(19) United States
(12) Patent Application Publication
(10) Pub. No.: US 2023/0134130 A1
(43) Pub. Date: May 4, 2023

(54) METHOD AND APPARATUS FOR ADAPTING A SCENE RENDERING

(71) Applicant: InterDigital CE Patent Holdings, Paris (FR)

(72) Inventors: Philippe Robert, Rennes (FR); Vincent Alleaume, Pace (FR); Matthieu Fradet, Chanteloup (FR); Tao Luo, Cesson-Sevigne (FR)

(21) Appl. No.: 17/911,898

(22) PCT Filed: Mar. 8, 2021
(86) PCT No.: PCT/EP2021/055782

§ 371 Date: Sep. 15, 2022

(30) Foreign Application Priority Data
Mar. 17, 2020 (EP) 20305277.4

(51) Int. Cl. G06T 15/50

(52) U.S. Cl. CPC G06T 15/506; G06T 2200/24

(57) ABSTRACT

According to embodiments, a (e.g., plurality of) lighting model(s) may be computed from a scene model by a processing device. The model (e.g., a geometric model of the scene complemented by a lighting model(s)) may be stored, for example on the processing device. The processing device may be coupled with a user interface running on any of the processing device or another (e.g., Tenderer) device. According to embodiments, a (e.g., specific) scene, for example, among a set of possible scenes, may be selected via the user interface, for being rendered by the AR application on any of the processing device and a (e.g., different) Tenderer device. According to embodiments, a (e.g., specific, virtual) outdoor lighting condition may be selected via the user interface, and a rendering of the selected scene may be adapted by the AR application according to the selected outdoor lighting condition.

### 1. TECHNICAL FIELD

The present disclosure relates to the domain of environment modelling, especially light modelling for various applications such as augmented reality applications.

### 2. BACKGROUND ART

Interior design applications may assist a user in selecting a specific furniture for a room by rendering a mixed scene of that room, where different virtual furniture elements may be virtually integrated in the room. When an interior of the room includes an opening (e.g., a window) to the outdoor environment, lighting effects on a furniture element may impact design choices. A user may have selected a furniture element fora room by running an interior design application in that room, for example, during a cloudy and rainy day. After acquisition of that furniture element, he may then be disappointed of a lighting effect on that element, for example, occurring during a sunny day. The present disclosure has been designed with the foregoing in mind.

### 3. SUMMARY

According to embodiments, a (e.g., plurality of) lighting model(s) may be computed from a scene model by a processing device. The model (e.g., a geometric model of the indoor scene complemented by a lighting model(s)) may be stored, for example on the processing device. The processing device may be coupled with a user interface running on any of the processing device and another (e.g., renderer) device. According to embodiments, a (e.g., specific) indoor scene, for example, among a set of possible indoor scenes, may be selected via the user interface, for being rendered by the AR application on any of the processing device and a (e.g., different) renderer device. According to embodiments, a (e.g., specific, virtual) outdoor lighting condition may be selected via the user interface, and a rendering of the selected indoor scene may be adapted by the AR application according to the selected outdoor lighting condition.

### 4. BRIEF DESCRIPTION OF THE DRAWINGS

FIG. 1 is a diagram illustrating an example of an augmented reality application based on multiple simulated scene lighting conditions;

FIG. 2 is a diagram illustrating an example of an (e.g., indoor) lighting estimation processing module;

FIG. 3A a diagram illustrating an example of a processing device for adapting a rendering of an indoor scene;

FIG. 3B a diagram illustrating another example of a processing device for adapting a rendering of an indoor scene;

FIG. 4 is a diagram representing an exemplary architecture of a processing device of any of the FIGS. 3A and 3B

FIG. 5 is a diagram illustrating an example of a method for adapting a scene rendering.

It should be understood that the drawing(s) are for purposes of illustrating the concepts of the disclosure and are not necessarily the only possible configuration for illustrating the disclosure.

### 5. DESCRIPTION OF EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the term “interconnected” is defined to mean directly connected to or indirectly connected with through one or more intermediate components. Such intermediate components may include both hardware and software-based components. The term “interconnected” is not limited to a wired interconnection and also includes wireless interconnection.

All examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Embodiments described herein may be related to any of augmented, mixed and diminished reality applications. For the sake of clarity, embodiments described herein are illustrated with an augmented reality application example, but they may also be applicable to any of mixed reality and diminished reality applications. Augmented reality (AR) applications may enable an interactive experience of a real-world environment where the objects that reside in the real world may be enhanced by computer-generated perceptual information, such as for example, virtual objects inserted in any of an image and a model of the real-world environment.

According to embodiments, a mixed indoor scene may comprise a modelled real indoor scene and additional virtual furniture. Realistic rendering of such mixed indoor scene under, for example, various lighting conditions may allow to improve interior design application realism and efficiency. For example, realistic lighting elicited by outdoor lighting and constrained by a real indoor scene during the experience may allow to improve the realism of AR applications. In another example, outdoor lighting may be simulated (e.g., modelled) at any time of the day and/or with various meteorological conditions (sunny, cloudy . . . ), under daylight and/or combined with artificial lighting to obtain a lighting model targeting a specific indoor scene.

According to embodiments, the AR application may be, for example, an interior room design application, allowing to realistically render a mixed indoor scene composed of the modelled real indoor scene and additional virtual furniture on a display device (e.g., a tablet), under various lighting conditions. The AR application may allow a user to evaluate possible interior design solutions with various pieces of furniture, natures of surfaces and lighting conditions.

AR indoor scenes lighting and rendering with high quality may be based on baking techniques, where, for example, lighting effects may be baked in the texture at the modelling phase (e.g., the texture of the object in the model may be computed based on the current lighting of the corresponding object in the scene). For example, baking a lighting effect in the texture of a modelled scene may prevent the AR application to adjust the lighting effect at runtime without any computationally intensive model update. For example, baking lighting effects in the texture may prevent the AR application to introduce new virtual (e.g., realistically lighted) objects, move existing objects of the modelled scene (to differently lighted areas) without any computationally intensive model update.

Throughout embodiments described herein the terms “part of a model”, model element, elementary model may be used interchangeably to describe any of a piece, a subset of a (e.g., any of a geometric, lighting) model of a scene that may include information (e.g., focusing) on a specific part (e.g., function) of the scene modelling.

According to embodiments any of direct and ambient lighting may be obtained (e.g., estimated) from images of a scene, based on, for example, any of shadows cast by objects and specular effects on surfaces. For example, shadows cast by an object may be detected onto neighbouring surfaces. A set of virtual shadows cast by a set of virtual point lights at different (e.g., predefined) 3D locations in the scene may be obtained (e.g., via 3D rendering from scene geometry), and compared to the detected shadow. Any point light that may create virtual shadows similar to the real detected ones may be selected as representing a scene lighting. For example, any of the color and the intensity of any of the point lights and an ambient lighting may be based on an analysis of the surfaces including areas with and without cast shadows.

According to embodiments, lighting of a scene may be obtained based on observing (e.g., processing an image of) the environment, for example, using any of a (e.g., fish-eye, wide angle) camera and observing a light probe (e.g. a metallic sphere) from a standard camera. For example, specular reflections of lights may be detected in images captured from different viewpoints, and 3D location of point lights may be obtained in the scene from these various observations (e.g., images), based on the geometry of the scene and on viewpoints poses.

According to embodiments, a set of outdoor lighting conditions may be represented as a (e.g., finite) set of models, where a model may be obtained (e.g., computed) based on combining any of (e.g., specific) meteorological conditions (e.g., any of sunny, cloudy, rainy . . . ), a day of year and a time of day.

According to embodiments, the outdoor model may include a direction of the sun which may depend on any of the 3D location (e.g., any of latitude, longitude positions) of the indoor scene, the day of year and the time of day. The terms “3D location” and “location” may be used interchangeably to designate a position of a (e.g., real) indoor scene on Earth. The location of the indoor scene may be represented, for example by any of a latitude position, a longitude position, a set of GPS coordinates, . . . . Optionally, the location of the indoor scene may also include an altitude (e.g., relative to the sea level). The terms “3D location” and “location” may be used interchangeably to designate a position (e.g., of any of a point, an object) in the indoor scene. For example, a position (e.g., of a point) in the indoor scene may be relative to a centre of the indoor scene. For example, the location of the indoor scene (any of a latitude position, a longitude position, a set of GPS coordinates) may be identical to the location of the centre of the indoor scene. In another example, the location of the centre of the indoor scene may be represented as relative to the location of the indoor scene

According to embodiments, the direction of the sun may be evaluated based on (e.g., a knowledge of) the 3D location of the indoor scene, the day of year and the time of day. In a first example the 3D location of the indoor scene may be configurable via a user interface. In another example, the 3D location of the indoor scene may be retrievable from the (e.g., geometric) model of the indoor scene. For example, an outdoor lighting model at a 3D location and time may comprise any of a direction, a color and an intensity of the sun and any of a color and an intensity of the sky. According to embodiments, a (e.g., set of indoor) lighting model(s) of an indoor scene may be obtained (e.g., computed, received) based on a model (of any of geometry, texture and reflectance) of the indoor scene and a (e.g., set of) lighting condition(s). According to embodiments, (e.g., indoor) lighting may be referred to herein as lighting in the indoor scene elicited by outdoor lighting. For example, for a (e.g., each) indoor lighting model a set of any of point lights and environment maps illuminating the indoor scene may be determined, with their parameter's values. In another example an (e.g., indoor) lighting model may include an ambient light with parameters (e.g., any of color and intensity). Parameters of a point light may be, for example, any of a location (e.g., in the scene), a color, and an intensity. Parameters of an environment map may be, for example, any of a location (e.g., in the scene) and an image).

According to embodiments, a lighting model may be (e.g., obtained and) sent in response to a user request.

In a first example, which may be referred to herein as “live navigation”, a user may be physically present in the indoor scene. The user may be enabled to navigate and simulate various (e.g., different) outdoor lighting conditions. In an AR (e.g., immersive) application, a device may display the view of the indoor scene that the device camera may be (e.g., currently) capturing. The pose of the camera in the indoor scene may be, for example, (e.g., continuously) estimated. The captured image may be modified according to parameters (e.g., configurable by a user via a user interface) by relighting the indoor scene based on its (e.g., registered) model (e.g., geometry, lighting), and the result may be displayed (e.g., rendered) on the device. In this example, the relighted texture may be any of a texture of a captured image for the visible real objects, and a texture attached to the geometry for the virtual parts of the indoor scene (e.g., any of inserted virtual objects, modified surface textures . . . )

In a second example, which may be referred to herein as “virtual navigation”, the user may not be present in the scene. The user may be enabled to virtually navigate in a relighted scene rendered from its model (any of geometry, texture, reflectance, lighting).

In a third example, a user may be enabled to change the mood of a room (in any of a live and virtual navigation), for example, by turning rain into sunshine (e.g., or vice versa), or by changing the experience from night to day (e.g., or vice versa).

In a fourth example, which may be referred to herein as mixed reality telepresence, at least two users may be in communication (via audio video data), although being located in different time zones and whether conditions. One of the users (e.g., located in UK) may wish to adapt the rendering of his own indoor scene to the virtual outdoor condition of another user (e.g., located in Australia). In another example, any local indoor scene rendering may be adapted based on a (e.g., common) virtual outdoor condition of a location where the users, for example, wish they would be meeting (e.g., virtual Maui conference using current time & weather in Maui).

According to embodiments, any number of lighting models may be selected (e.g., via a user interface), for example, to evaluate (or simulate) the interior (e.g., design) of a room under various lighting conditions. According to embodiments, a user may be enabled to modify other elements of the real scene such as, for example, any of objects (e.g., removal, insertion), textures of the surfaces, . . .

According to embodiments, a user may run an AR application for navigating in an indoor scene, rendering the indoor scene on a rendering (e.g., display) device under various (e.g., varying) lighting conditions. The AR application may correspond to a real scene (e.g., the room where the user may be standing) or to any other modelled scene. A model of the indoor scene, for example, including any of a geometry, a texture and a reflectance information, may be obtained by any modelling technique known to the skilled in the art.

In a first example of modelling technique may use a photogrammetry (science of making measurements from photographs) approach. Photogrammetry may infer the geometry of a scene from a set of unordered captured images or videos. A captured image may be seen as a projection of a 3D scene onto a 2D plane, losing depth information. Photogrammetry may be seen as a way to reverse this process. For example, from a (e.g., large) set of captured (e.g., color) images of the scene, and knowing the intrinsic parameters of the camera(s) having captured the scene, the camera pose and the depth map related to an (e.g., each) image may be obtained (e.g., estimated). Any of a geometry and a texture of a model may be obtained based on the captured image and the estimated depth map. The accuracy of this method may depend on any of the number of captured images and the texture variety in the captured images of the scene. The modelling technique may comprise a scale correction step to obtain a model fitting the real scene's dimension.

In a second example, a model of a scene may be obtained by capturing images of the scene with an additional depth information using, for example, any of color and depth sensors. For example, additional hardware such as any of an inertial measurement unit (IMU) and a simultaneous localization and mapping (SLAM) algorithm may allow to retrieve an (e.g., each) image pose and to obtain (e.g., estimate) the scene model (e.g., any of geometry and texture information). In a variant, specular reflectance of the surfaces of the scene may also be estimated by processing captured images of the scene.

In a live navigation example, a (e.g., 3D textured) model of the scene may have been obtained (e.g., preliminary to the execution of the AR application), for example, based on a set of data acquired in the room. For example, any of images, a related camera pose, a reference to a specific object allowing to obtain a model centre and orientation may be acquired in the scene. A model centre and orientation may allow the modelled scene to be (e.g., correctly) rendered in front of the user device, based on the (e.g., any of real, virtual) location and orientation of the user device in the scene during the rendering.

According to embodiments, a model of an indoor scene may include any of a location of the scene (e.g., longitude, latitude position), an orientation of the scene (e.g., relative to north) and an altitude of the scene (e.g., relative to the sea level). Any of the location, orientation and altitude of the scene may be obtained, for example, from any of a geographic map information, building plans, and other means. In another example, for a (e.g., each) image of a scene, any of a pose, an altitude and an orientation of the capturing device may be obtained from the device capturing the image of the scene. Any of the location, orientation and altitude of the (e.g., modelled) scene may be obtained based on a set of captured images, where at least one captured image may be associated with any of a location, orientation and altitude of the device having captured that image. Any of the location, orientation and altitude of a device may be obtained from a variety of sensors of the device (e.g., IMU, GPS, compass, altimeter, . . . ).

According to embodiments, a model of an indoor scene (e.g., comprising any of geometry, texture and reflectance information) may be obtained by a processing device. For example, the model may be computed by the processing device based on any technique as previously described. In another example, the model may be received by the processing device from another device having computed it. According to embodiments, the model of the scene may be stored on the processing device after having been obtained. According to embodiments, the indoor scene may correspond to a set of indoor scenes, where an indoor scene may be identified by an identifier. For example, the processing device may be requested (via any of a user interface and a network interface) to provide a (e.g., specific) relighted indoor scene. The processing device may send the (e.g., indoor) lighting model corresponding to the requested indoor scene and to the requested lighting conditions. In another example, the processing device may be requested (via any of a user interface and a network interface) to render a (e.g., specific) relighted indoor scene. The processing device may render the requested indoor scene relighted according to requested lighting conditions.

According to embodiments, the processing device may process (e.g., indoor) lighting models for scenes lit by outdoor lighting. For example, the processing device may obtain an (e.g., indoor) lighting model of an indoor scene (e.g., identified by a scene identifier), based on a model of that scene and on an instance of outdoor lighting conditions. Any number of (e.g., indoor) lighting models of an indoor scene may be obtained based on any number outdoor lighting conditions (e.g., an (e.g., indoor) lighting model of an indoor scene corresponding to an instance of outdoor lighting conditions). For example, multiple instances of outdoor lighting conditions may comprise any of a day of year, time of day and meteorological condition (e.g., sunny, cloudy, rainy, stormy . . . ). According to embodiments, the 3D location of the indoor scene (e.g., configured via a user interface) may provide (e.g., allow to determine) the direction of the sun (e.g. azimuth angle with respect to the north direction and tilt with respect to the horizontal plane at the 3D location) to be associated with (e.g., each) outdoor lighting condition for the current indoor scene.

According to embodiments, the model of the indoor scene may comprise any of geometry, texture and reflectance information. In a first example the (e.g., indoor) lighting model may be obtained based on a model of the scene comprising only geometric information of the scene (which may be referred to herein as a geometric model). Geometric information may comprise any of shapes, dimensions, orientations, locations etc. . . . of objects in the scene. In a second example the (e.g., indoor) lighting model may be obtained based on a model of the scene comprising information on geometry and texture. In a third example the (e.g., indoor) lighting model may be obtained based on a model of the scene comprising information on geometry, texture and reflectance of surfaces of the scene.

According to embodiments, after reception of a request for an indoor scene lit under a specific outdoor lighting condition, the processing device may select and send the (e.g., indoor) lighting model of the indoor scene corresponding to the requested outdoor lighting condition. In a variant, the processing device may send the model of the scene together with the (e.g., indoor) lighting model of the scene. In another variant, any number (e.g., all) of (e.g., indoor) lighting models of a scene may be sent by the processing device to a rendering device. In a variant, the request may be received from a local user interface of the processing device, and the model of the scene may be rendered by the processing device according to the requested (e.g., indoor) lighting model. The user may navigate in the indoor scene through the processing device and may observe the indoor scene under the requested outdoor lighting condition. According to embodiments, virtual objects may be inserted in the indoor scene. According to embodiments, virtual objects may include a lighting object (e.g., a desk lamp) impacting (e.g., complementing) the (e.g., indoor) lighting model of the indoor scene.

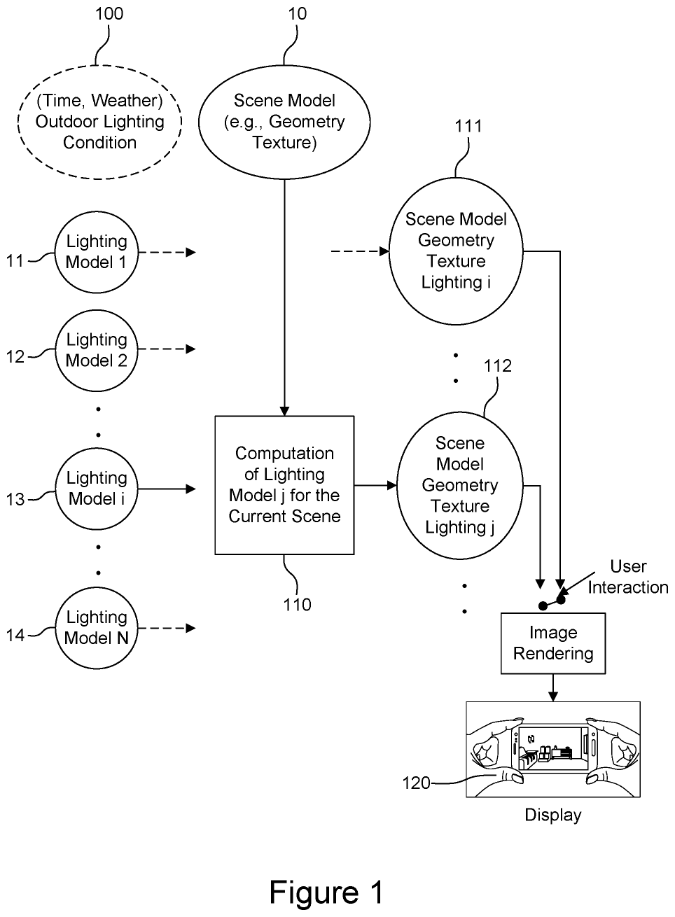

FIG. 1 is a diagram illustrating an example of an augmented reality application based on multiple simulated scene lighting conditions. According to embodiments a generic lighting model 11, 12, 13, 14 may be obtained (e.g., parametrized) based on an outdoor lighting condition 100. According to embodiments, a processing module 110 may compute an (e.g., indoor) lighting model 111, 112 of the indoor scene based on a (e.g., parametrized) lighting model 11, 12, 13, 14 and on a model 10 of a scene comprising any of geometry, 3D location and texture information of the scene. According to embodiments, the processing module 110 may receive a (e.g., set of) model(s) of the indoor scene. According to embodiments, the processing module 110 may receive a (e.g., set of parametrized) lighting model 11, 12, 13, 14, representing different outdoor lighting conditions. According to embodiments, for a (e.g., each) model 10 of the indoor scene, a set of (e.g., scene dependent, indoor) lighting models 111, 112 may be obtained based on the (e.g., set of parametrized) lighting models 11, 12, 13, 14, a scene dependent (e.g., indoor) lighting model 111, 112 corresponding to a (e.g., specific) outdoor lighting condition instance. According to embodiments, the scene dependent (e.g., indoor) lighting models 111, 112 associated with different outdoor lighting conditions may be stored on a processing device running the processing module 110. According to embodiments, an external renderer device 120 may send a request (to the processing module 110 for an indoor scene under a virtual outdoor lighting condition. The request may, for example, include an information indicating the requested virtual outdoor lighting condition. If the processing device is configured to process more than one scene, the request may, for example, further include an information indicating the scene to be rendered. The request may, for example, also include a 3D location of the scene to be rendered. In another example the 3D location of the scene may have been preliminary obtained by the processing device (e.g., any of via a user configuration, and during the modelling of the scene). According to embodiments, the processing module 110 may send the scene model 10 complemented with the (e.g., indoor) lighting model of the indoor scene 111, 112 corresponding to the requested virtual outdoor lighting condition. The external renderer device 120 may render the indoor scene lit by the requested virtual outdoor condition. In a variant, the processing module 110 may be requested, e.g., via a user interface, to render a indoor scene lit by a virtual outdoor condition and may locally render the indoor scene based on the (e.g., indoor) lighting model 111, 112. According to embodiments, a user may be enabled to navigate in the indoor scene under a specific simulated (e.g., virtual) outdoor lighting condition.

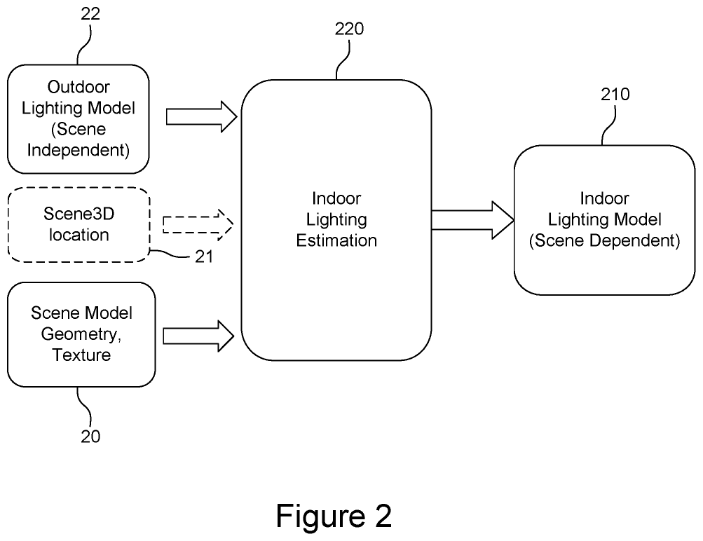

FIG. 2 is a diagram illustrating an example of an indoor lighting estimation processing module. A processing module 220 may be configured to obtain a scene-dependent (e.g., indoor) lighting model 210 from a generic outdoor lighting model 22 and the model of the indoor scene 20. In a first example, the model of the indoor scene 20 may include a 3D location 21 of the scene. In a second example the 3D location 21 of the indoor scene may be configurable (e.g., via a user interface), and the scene-dependent (e.g., indoor) lighting model 210 may be obtained based on the generic outdoor lighting model 22, the model of the scene 20, and the 3D location 21 of the indoor scene.

According to embodiments, a (e.g., generic, scene-independent) outdoor lighting model may be obtained, corresponding to any of various (e.g., different) meteorological conditions, times of the day, and days of a year. For example, at a given time of the day (e.g., of a year) and with specific weather conditions, a generic outdoor lighting model may comprise any of a direction (e.g., derived from time of day and 3D location of the scene), a color and an intensity of the sun. For example, (e.g., at the given time of the day and with specific weather conditions), a generic outdoor lighting model may comprise any of a color and an intensity of the sky. For example, the sky lighting may be represented in the outdoor lighting model by a (e.g., single) color parameter controlled by a parameter (e.g., derived from a slider of a user interface), from blue to milky, grey and dark grey. In a first example, a (e.g., generic) outdoor lighting model may comprise a set of (e.g., sample, discrete) model instances sampling the various possible situations. In a second example, the (e.g., generic) outdoor lighting model may be a (e.g., single, parametric) model, an instance of which may be obtained via parametrization (e.g., parameter tuning). According to embodiments, an instance of such models may be configurable (e.g., selectable) by the user via a user interface (e.g., using sliders). According to embodiments, the generic outdoor lighting model may be parametrized by a (e.g., target) location parameter (e.g., any of latitude, longitude, altitude) of the scene. Any of the sky and sun lighting may, for example, be further adjusted based on the targeted location.

The direction of the sun may be defined by a parametric model taking into account the 3D location of the lighting experience, the day of the year and the time of day. From the 3D location the time zone may, for example, be identified. Then from the 3D location, the time zone, and the day of the year and time of day given by the user, the direction of the sun may, for example, be obtained.

According to embodiments, a (e.g., scene dependent) (e.g., indoor) lighting model adapted to the indoor scene may be obtained (e.g., computed) based on a (e.g., instance) of the (e.g., generic) outdoor lighting model, the 3D location of the scene and the (e.g., geometric) model of the scene. For example, the (e.g., indoor) lighting model may comprise any of a directional light (e.g., derived from the light of the sun), and a (e.g., set of) environment map located in the scene. An environment map may approximate the appearance of a reflective surface around a (e.g., 3D) location in the scene. An environment map may be represented as a spherical image, a cube map. The image may have a rough (e.g., limited, reduced) resolution to (e.g., only) display the main lighting reflections (e.g., without any textures details). The lighting information may be, for example, encoded as spherical harmonics basis functions. According to embodiments, an environment map may be obtained (e.g., computed) based on a (e.g., selected) outdoor lighting model instance. According to embodiments, in addition to direct lighting, an (e.g., indoor) lighting model may comprise an ambient lighting, e.g., instead of an environment map. Unlike the other lighting models, ambient lighting may combine corresponding ambient color with surface reflectance without considering any surface orientation.

For example, the (e.g., indoor) scene may comprise an opening to the outside. The opening may be any of window and a door. More generally, any opening to the outside allowing (e.g., outside lighting conditions) to influence the lighting of the indoor scene may be applicable to embodiments described herein. According to embodiments, any of an opening (e.g., any of a window, a door), its orientation (e.g. relative to any of the north and to the vertical axis), its location (e.g., any of latitude, longitude position) and its geometry (e.g., size, shape) may be obtained from the (e.g., geometry of the) model of the indoor scene. For example, the geometric model of the indoor scene may comprise information on the geometry of the opening. The information on the geometry of the opening (which may be referred to herein as model of the opening) may include information on any of an orientation of the opening (e.g. relative to any of the north and to the vertical axis), a location of the opening (e.g., any of latitude, longitude position) and a geometry of the opening (e.g., size, shape).

For example, the (e.g., indoor) lighting model of the indoor scene may include a part of the model, which may also be referred to herein as lighting model element, associated with (e.g., corresponding to) the opening. The lighting model element associated with the opening may model the lighting of the indoor scene as induced by the opening. The lighting model element associated with the opening may be based on the model of the opening and on the virtual outdoor condition. For example, any of the direction, color and intensity of the sun in the (e.g., indoor) lighting model may be obtained based on any of the direction, color and intensity of the sun of the outdoor lighting model instance applied at the 3D location of the scene and on any of the location, orientation, and geometry of the opening in the scene.

According to embodiments, the (e.g., indoor) lighting model may be obtained (e.g., complemented) based on the geometry of the environment of the scene, such as, for example, neighbouring buildings that may (e.g., partly) occlude the sun). Any of the directional light and color of the sun in the areas (e.g., impacted by the environment) may be derived accordingly. According to embodiments, sunlight may illuminate the indoor scene through openings (any of windows and doors . . . ). According to embodiments, potential outdoor neighbouring buildings may act (e.g., be processed) as additional occlusion masks applied to scene openings. For example, diffuse skylight intensity may be weighted via the percentage of visible sky from the scene openings in presence of neighbouring buildings.

According to embodiments, the (e.g., indoor) lighting model may comprise (e.g., additionally) any of point lights and an area light to complement the model by considering the diffuse aspect of current direct lighting (e.g. soft shadows) and the geometry of the openings (e.g. windows). For example, any of complementary point lights and area light may be obtained by any lighting estimation method, e.g., considering openings may also diffuse sky lighting inside the indoor scene.

According to embodiments, ambient lighting may be used in the (e.g., indoor) lighting model to light the surfaces of the model that do not receive direct lighting. For example, any of the color and intensity of the ambient lighting may depend on any of the direct lighting, geometry, texture and reflectance of the indoor scene. For example, any of the color and intensity of the ambient lighting may be set to constant values throughout the scene.

According to embodiments, a (e.g., set of) environment map(s) may be used in the (e.g., indoor) lighting model to consider indirect lighting (e.g., illuminating the surfaces of the model that do not receive direct light). Depending on the complexity of the scene (e.g., geometry, texture, reflectance) and on a rendering quality, any number of environment maps may be used. A single environment map may, for example, allow to realistically render a simple scene (e.g., empty single room with relatively uniform texture on surfaces (e.g., white surfaces). Higher densities of environment maps may allow to improve the realism of the rendering for more complex scenes.

According to embodiments, a (e.g., single indoor) lighting model of a scene may be obtained based on a (e.g., set of) image(s) of the indoor scene captured under a (e.g., single) outdoor condition, for example, at (e.g., different) place(s) in the indoor scene. The obtained (e.g., indoor) lighting model may be associated with an outdoor condition, (e.g., corresponding to the real outdoor conditions in which the images(s) of the indoor scene were captured). The (e.g., indoor) lighting model may be estimated from the captured images based on any lighting model estimation technique known to the skilled in the art.

According to embodiments, a set of (e.g., indoor) lighting model instances of a scene may be obtained (e.g., pre-determined) based on a (e.g., set of) image(s) of the scene captured in the indoor scene under various (e.g., different) outdoor lighting conditions (e.g., at different times and/or different weather conditions). A (e.g., each) pre-determined (e.g., indoor) lighting model instance may be associated with an (e.g., different) outdoor lighting condition, (e.g., corresponding to the real outdoor lighting condition in which the corresponding images(s) of the scene were captured). An outdoor lighting condition, in which a set of images were captured for estimating a (e.g., specific, pre-determined indoor) lighting model instance may be referred to herein as a captured outdoor lighting condition. According to embodiments, an (e.g., indoor) lighting model of the scene may be obtained based on a (e.g., user selected) virtual outdoor condition by selecting the pre-determined (e.g., indoor) lighting model instance associated with a captured outdoor lighting condition similar to the virtual outdoor condition. In a first example, the pre-determined (e.g., indoor) lighting model instance associated with the closest (e.g., most similar) virtual outdoor condition may be selected. In a second example, the (e.g., indoor) lighting model instance may be obtained based on an interpolation of at least two pre-determined (e.g., indoor) lighting model instances respectively associated with at least two (e.g., most) similar captured outdoor lighting conditions. According to embodiments, similarity between outdoor lighting conditions may be defined by vectorizing parameter values of an outdoor lighting condition, and computing any of Hamming and Euclidian distances between two vectorized outdoor lighting conditions.

According to embodiments, in a live navigation, a user may be capable of visiting a scene through his device, displaying an image corresponding to the scene under a user specified lighting condition. For example, the displayed image may correspond to the (e.g., current) device pose so that the user may aim the device towards a particular place of the scene and see the corresponding virtual scene on the display. In a first example, the displayed image may result from a rendering based on the (e.g., geometric and textured model of the scene and on the (e.g., indoor) lighting model (e.g., similar to a virtual navigation, wherein the rendering viewpoint may be determined based on the device pose). In a second example, the device may display the image (e.g., video) currently captured by the device, after having relighted it from the (e.g., indoor) lighting model (e.g., based on geometry and possibly specular reflectance data). In the second example, the texture information of the scene may be extracted from the current image (e.g., instead of from the model of the scene as in the first example). The rendering process may combine the extracted texture with any light-dependent component resulting from geometry (surface orientation) and (e.g., indoor) lighting modelling (direction, color, intensity . . . ). The second example may be applicable if the (e.g., current) lighting of the image (e.g., video) is soft (without any strong shadows or highlights). In case the captured image (e.g., video) comprises (e.g., strong, significant) light effects (shadows, highlights), the lighting effects may be removed before relighting the image (e.g., video).

According to embodiments, a virtual object may be introduced (e.g., by the user) in the scene. The virtual object may be lighted according to an (e.g., indoor) lighting model reflecting the lighting of the real indoor scene. In a first example, an (e.g., indoor) lighting model may be obtained (e.g., estimated), for example, from images of the indoor scene captured by a device (e.g., camera). For example, lighting parameter values of the lighting model may be estimated from the captured images and the model of the scene. The (e.g., estimated) lighting parameter values may be used for relighting the inserted virtual object. In a second example, the set of parameter values (e.g., lighting model instance) in the set of lighting model instances that may be closest to the set of estimated parameter values may be selected for virtual objects relighting.

According to embodiments, a device may render (e.g., display) an image of the scene, including an area that may not have been modelled in the model of the scene. Such an area may, for example, appear in the field of view of the camera of the device running the AR application, although not having been modelled. In a first example, the corresponding area of the image may be color-corrected according to the (e.g., indoor) lighting model to reduce potential differences between the (e.g., un-modelled) area and the modelled relighted parts of the scene. In a second example, an ambient lighting component may be applied to reduce the potential differences between the (e.g., un-modelled) area and the modelled relighted parts of the scene.

According to embodiments, artificial lighting (e.g. outdoor streetlights, indoor ceiling lights, desk lamps . . . ) may be considered in the rendering process by associating a lighting model with them. An (e.g., indoor) lighting model may, for example, comprise an (e.g., additional) elementary lighting model representing an artificial light source. In a first example, the indoor scene may comprise an artificial light source, which may have been detected and modelled as an artificial light elementary model in the (e.g., indoor) lighting model of the scene. In a second example, artificial light elementary models may be made available to the user (e.g., for addition in the (e.g., indoor) lighting model) via the user interface. According to embodiments, artificial light elementary models may be any of e.g., pre-determined and stored in the device running the AR application. According to embodiments, artificial light elementary models may be stored into and accessible from a database.

According to embodiments, the (e.g., indoor) scene may be, for example, any of an apartment, a house and premises. The (e.g., geometric) model may, for example, define the notions of indoor and outdoor. In this context, any hole outwards may be assimilated to a window. For example, the (e.g., geometric) model may comprise an explicit designation of openings (e.g. any of windows, doors . . . ). According to embodiments, openings may have their own explicit model (e.g. any of window shape and dimensions). According to embodiments, windows may be equipped with shades or blinds that may be modelled with a variable (e.g., parametric) model (e.g. degree of shadowing, of openness . . . ). According to embodiments, a status of such equipment may be (e.g., virtually) adjustable via a user interface to enable a wide range of ambient lighting.

According to embodiments, the AR application may allow to simulate the effect of the scene orientation with respect to the cardinal points, for example to experiment the effect of sunlight on the (e.g., indoor) lighting. According to embodiments the orientation of the scene (e.g., with respect to the cardinal points) may be adjustable. According to embodiments virtual obstacles (e.g., representative of neighbouring building) may be added to the model of the scene, for example, via a user interface, enabling a user to test the effect of the presence of hypothetic obstacles to outdoor lighting next to the scene.

### User Interface Example for Scene Rendering Adaptation Configuration

An example of a user interface for entering information for configuring (e.g., parametrizing) the scene rendering adaptation is described herein. For example, the user interface may include a first part which may be dedicated to the indoor scene configuration and a second part which may be dedicated to the outdoor lighting model configuration.

For example, the processing device (e.g., which may be running the AR application), may be localized. For example, a model of a scene (e.g., where the processing device may have been localized) may be available and may be displayed (e.g., rendered) via the first part of the user interface. For example, a list of scenes (e.g., model(s)) may be displayed, e.g., together with selection means allowing a user to select one scene (e.g., model) among others.

For example, the indoor scene may be located in (e.g., belong to) any of an apartment, a house and premises. For example, the location may be available. The indoor scene may correspond, for example, to an existing apartment (e.g., a house, premises), or to a not yet existing one, but for which e.g., plans and a model may be available. For example, the environment of the scene may be pre-determined (e.g., pre-configured). The environment (e.g., buildings, trees, . . . ) may be adjustable via the user interface, (e.g., to anticipate possible impacts of the environment changes).

For example, the building including the indoor scene may be moved to another location via the user interface such that it may be located in another environment. This may allow to simulate the impact of another environment on the lighting model of the indoor scene.

According to embodiments, an indoor scene may be selected via the user interface. For example, any of a (e.g., default 3D) location and an orientation (e.g. horizontal orientation with respect to the north) of the indoor scene and a (e.g., default) environment of the indoor scene may be available. For example, any of the location, orientation and the environment may be adjustable (e.g., configurable, modifiable) via the user interface. This may allow the user to localize or orientate the scene differently, or e.g. to any of add and remove close obstacles (e.g., buildings or trees). The environment may be displayed, for example, as a (e.g., 2D) map representing the top view of the area and including the building of the scene and other near buildings. The (e.g., 2D) map may correspond, for example, to any of an existing environment, a planned environment, and a virtual environment (e.g., where buildings may be added by the user). The building may be, for example, built from parallelepipeds that may be any of placed on the map and overlapping on each other, e.g., configurable by the user interface (e.g., including dimensions).

According to embodiments, the model of the indoor scene may include at least an information describing the geometry of the scene. For example, the model may further include any of texture and reflectance information (e.g., parameters) of the indoor scene. In a case where the model does not contain any texture or reflectance information, default texture (e.g., and reflectance) may be applied. For example, the user interface may propose (e.g., display an information proposing) to the user a set of possible textures (e.g., any of various intensities and colors) and reflectance (e.g. specular levels), to be selected for the (e.g., different) surfaces included in the (e.g., geometric) model.

According to embodiments, the information describing the geometry of the indoor scene may include a description of the openings (e.g., to the outside), for example, with any of the 3D location and orientation of the scene (e.g., in world space). For example, (e.g., a set of possible) occluding objects may be assigned to (e.g., associated with) the openings via the user interface, such as e.g., any of shades, blinds, and shutters. For example, parameters of these occluding objects may be adjustable (e.g., tuneable) via the user interface, such as e.g., the degree of closing of the blinds (e.g., or shutters).

According to embodiment, a second part of the user interface (e.g., which may be dedicated to the outdoor lighting model configuration), may display, for example, a list of weather conditions (e.g., sunny, cloudy, rainy, . . . ) from which a particular instance may be selected. For example, any of the time of the day and a day of the year may be selected (e.g., configurable) via the user interface. An outdoor lighting model may be derived based on these selections (e.g., configurations) according to any embodiment described herein.

According to embodiments, the lighting model of the selected indoor scene associated with (e.g., lit by outdoor lighting that may result from) an outdoor environment and an outdoor lighting model may have been, for example, pre-computed and may be available for AR application. In another example, the lighting model of the selected indoor scene may be unavailable e.g. because the current (e.g., lighting) configuration comprising any of the scene, its location, its orientation, the outdoor environment and the outdoor lighting model may not have been pre-computed. According to embodiments, the lighting model of the indoor scene (e.g., lit by outdoor lighting that may result from any of an outdoor environment and a virtual outdoor condition (e.g., an outdoor lighting model)) may be obtained (e.g., computed) based on (e.g., the parameters describing) these components.

According to embodiments, any number of artificial indoor lights (e.g., any of indoor ceiling lights, desk lamps . . . ) may be included in the model of the (e.g., indoor) scene via the user interface. For example, the (e.g., indoor) lighting model of the (e.g., indoor) scene may be adjusted (e.g., recomputed, complemented) in a case where an indoor light is introduced (e.g., or removed) in the scene.

### Example of Relighting for Scene Rendering Adaptation

According to embodiments, a (e.g., selected, computed) instance of the (e.g., indoor) lighting model may be applied to the indoor scene, for example, based on the scene model (e.g., any of 3D geometry, texture, and reflectance). For example, an (e.g., each) image of the video of the (e.g., captured) scene may be replaced by a (e.g., computer graphics based) rendering image of the scene at the (e.g., current) viewpoint based on the model of the scene and on the (e.g., current indoor) lighting model. In a first example, the indoor scene may have been first augmented by e.g., inserting virtual objects in the scene model (e.g., including any of geometry, texture, and reflectance). In a second example, the indoor scene may have been modified (e.g., before rendering) e.g. by removing objects which may render visible reconstructed areas.

For example, the (e.g., current real) lighting may be homogeneous in an image (e.g., that may have been captured by a camera) of the indoor scene. A lighting in an image may be referred to as homogeneous in a case where e.g. there is no strongly lit areas contrasting with close shadow areas. In a case where the lighting is homogeneous in an image of the indoor scene, a new (e.g., virtual) lighting instance may be applied (e.g., directly) to the image of the video displayed by the processing device. For example, the image (e.g., that may have been captured by a camera) of the indoor scene may be used as texture of the scene model. For example, virtual objects may be inserted in the scene model, the resulting mixed image may be used as texture and may be modulated by the new (e.g., virtual) lighting instance applied to the mixed scene. For example, before applying the new (e.g., virtual) lighting instance, the (e.g., color) image of the indoor scene may be shifted to a reference that may correspond to the reference ambient lighting used for texture model.

For example, a homogeneous lighting in the (e.g., real indoor) scene may be detected by comparing the input image(s) of the scene (e.g., as captured by a camera) with their version(s) (same viewpoint) rendered (e.g., by the GPU) based on the scene model. An input image of the scene (e.g., as captured by a camera) may be referred to herein as I_{c}, and a corresponding image rendered based on the (e.g., texture of the) scene model may be referred to herein as Iₜ. For example, in a case where the difference between input image I_{c} and the texture-based rendered image Iₜ may be modelled through an affine transformation (e.g., Iₜ=A. I_{c}+B, with A and B the affine parameters), e.g., with an acceptable error, it may be determined that the input image may be used e.g., instead of the model texture for applying the new (e.g., virtual) lighting instance. An error may be acceptable, for example, in a case where the sum of (Iₜ-A. I_{c}-B)² over the image is below a (e.g., threshold) value.

For example, before applying the new (e.g., virtual) lighting instance the input image may be color-shifted (e.g. through transformation A.I_{c}+B). For example, color shifting an input image may comprise obtaining a color-shifted image of an input image, wherein the color values of the pixels or the color-shifted image may be obtained by a (e.g., affine) transformation of the color values of the corresponding pixels of the input image.

Relighting an image of a video (e.g., captured by a camera from the indoor scene) based on a lighting model instead of generating a lit texture-based image (e.g., from a GPU), may allow to provide a better realism of the scene displayed e.g., on the processing device screen, for example in case of (e.g., significant) errors in scene geometry.

For example, in the case where the lighting is not homogeneous in an image (e.g., that may have been captured by a camera) of the indoor scene, the texture of the scene model may be used instead of the image texture. For example, the scene may be rendered based on images that may be (e.g., computer graphics) generated based on the (e.g., geometric, textured) model of the scene and on the lighting model instance.

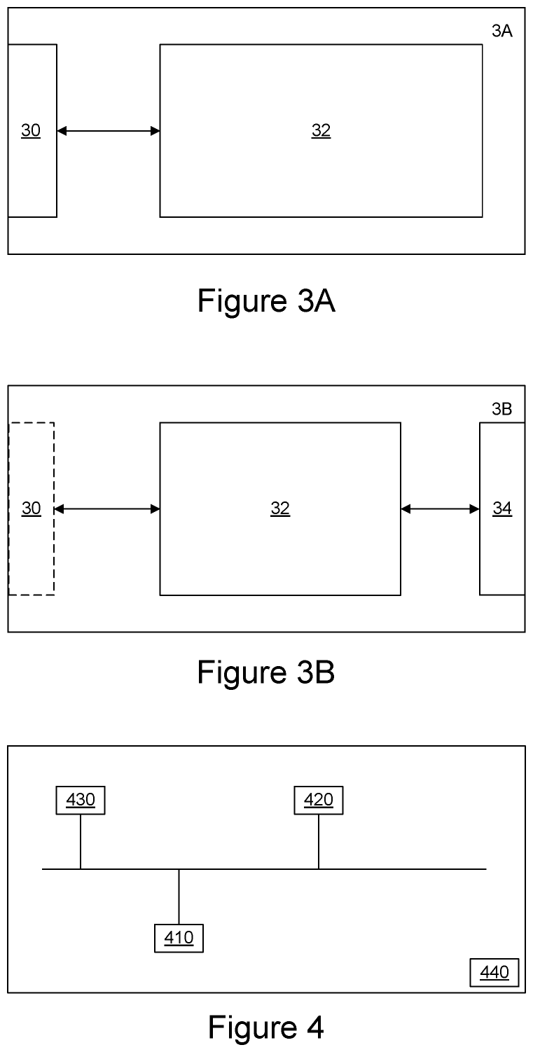

FIG. 3A is a diagram illustrating an example of a processing device 3A for adapting a scene rendering. According to embodiments, the processing device 3A may comprise a network interface 30 for connection to a network. The network interface 30 may be configured to send and receive data packets. According to embodiments, the network interface 30 may be any of:
a wireless local area network interface such as Bluetooth, Wi-Fi in any flavour, or any kind of wireless interface of the IEEE 802 family of network interfaces;
a wired LAN interface such as Ethernet, IEEE 802.3 or any wired interface of the IEEE 802 family of network interfaces;
a wired bus interface such as USB, FireWire, or any kind of wired bus technology.
a broadband cellular wireless network interface such a 2G/3G/4G/5G cellular wireless network interface compliant to the 3GPP specification in any of its releases;
a wide area network interface such a xDSL, FFTx or a WiMAX interface.

More generally, any network interface allowing to send and receive data packets may be compatible with embodiments described herein.

According to embodiments, the network interface 30 may be coupled to a processing module 32, configured to obtain an information indicating an indoor scene to be rendered under a virtual outdoor condition, for example, received via the network interface 30. According to embodiments, the information indicating an indoor scene to be rendered under a virtual outdoor condition may be received via a local user interface (not represented). According to embodiments, the processing module 32 may be further configured to obtain an (e.g., indoor) lighting model of an indoor scene based on a geometric model of the indoor scene and on the virtual outdoor condition. According to embodiment, the processing module 32 may be further configured to adapt the scene rendering by sending the (e.g., indoor) lighting model of the scene to an external renderer device via the network interface 30. According to embodiments the external renderer device may render (e.g., display images of) the indoor scene based on the model of the scene complemented by the received (e.g., indoor) lighting model. For example, both the (e.g., geometric, textured) model of the indoor scene and the (e.g., indoor) lighting model of the scene may be sent by the processing module 32 to the external renderer device. In another example, only the (e.g., indoor) lighting model may be sent by the processing module 32 to the external renderer device. The (e.g., geometric, textured) model of the scene may be made available to the external renderer device by any other means (received from another device, pre-configured, . . . ). In yet another example only a geometric model and an (e.g., indoor) lighting model may be sent by the processing module 32 to the external renderer device. A textured model of the indoor scene may be made available to the external renderer device by any other means (received from another device, pre-configured, . . . ).

According to embodiment, the processing device may be coupled with an (e.g., optional) user interface, running (e.g., and displayed) locally on the processing device 3A (not represented). According to embodiments the user interface may be running on another device, communicating with the processing device 3A via the network interface 30. The user interface may allow the processing device 3A to interact with a user, for example, for any of receiving captured images of a scene, receiving a model of a scene, adjusting some parameters of the model, receiving a request for rendering a scene under an outdoor condition . . .

FIG. 3B is a diagram illustrating an example of a processing device 3B configured to adapt a scene rendering. According to embodiments, the processing device 3B may comprise a processing module 32, configured to obtain an information indicating an indoor scene to be rendered under a virtual outdoor condition, for example, received via an optional network interface 30 (e.g., as described in FIG. 3A). According to embodiments, the information indicating an indoor scene to be rendered under a virtual outdoor condition may be received via a local user interface coupled to a display means 34. According to embodiments, the processing module 32 may be further configured to obtain an (e.g., indoor) lighting model of a scene based on a geometric model of the scene and on the virtual outdoor condition. According to embodiment, the processing module 32 may be further configured to adapt the scene rendering by rendering the scene on the display mean 34 based on the (e.g., geometric and textured) model of the scene and on the (e.g., indoor) lighting model of the scene.

According to embodiments the user interface may be running on another device, communicating with the processing device 3B via the network interface 30. The user interface may allow the processing device 3B to interact with a user, for example, for any of receiving captured images of a scene, receiving a model of a scene, adjusting some parameters of the model, receiving a request for rendering a scene under an outdoor condition . . . .

According to embodiments, the display means 34 may be any of internal and external to the processing device 3B. According to embodiments, the display means 34 may be a screen according to any display technology (e.g., LCD, LED, OLED, . . . ).

FIG. 4 represents an exemplary architecture of any of the processing devices 3A, 3B described herein. The processing device 3A, 3B may comprise one or more processor(s) 410, which may be, for example, any of a CPU, a GPU a DSP (English acronym of Digital Signal Processor), along with internal memory 420 (e.g. any of RAM, ROM, EPROM). The processing device 3A, 3B may comprise any number of Input/Output interface(s) 430 adapted to send output information and/or to allow a user to enter commands and/or data (e.g. any of a keyboard, a mouse, a touchpad, a webcam, a display), and/or to send/receive data over a network interface; and a power source 440 which may be external to the processing device 3A, 3B.

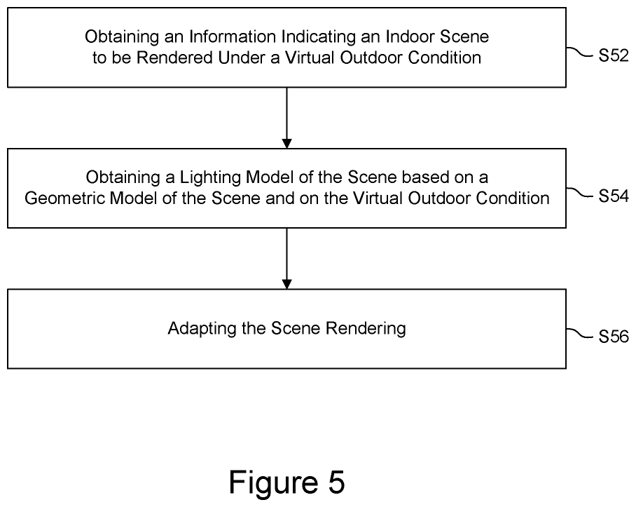

According to embodiments, the processing device 3A, 3B may further comprise a computer program stored in the memory 420. The computer program may comprise instructions which, when executed by the processing device 3A, 3B, in particular by the processor(s) 410, make the processing device 3A, 3B carrying out the processing method described with reference to FIG. 5. According to a variant, the computer program may be stored externally to the processing device 3A, 3B on a non-transitory digital data support, e.g. on an external storage medium such as any of a SD Card, HDD, CD-ROM, DVD, a read-only and/or DVD drive, a DVD Read/Write drive, all known in the art. The processing device 3A, 3B may comprise an interface to read the computer program. Further, the processing device 3A, 3B may access any number of Universal Serial Bus (USB)-type storage devices (e.g., “memory sticks.”) through corresponding USB ports (not shown).

According to embodiments, the processing device 3A, 3B may be any of a server, a desktop computer, a laptop computer, a networking device, a TV set, a tablet, a smartphone, a set-top box, an internet gateway, a game console.

FIG. 5 is a diagram illustrating an example of a method for adapting a scene rendering. According to embodiments, in a step S52, an information indicating an indoor scene to be rendered under a virtual outdoor condition may be obtained. The information may be obtained from any of a local user interface and a network interface.

According to embodiments, in a step S54, an (e.g., indoor) lighting model of the indoor scene may be obtained based on the 3D location and orientation of the indoor scene, a geometric model of the indoor scene and on the virtual outdoor condition. In a first example, any of the 3D location and orientation of the indoor scene may be configurable via a user interface. In a second example, any of the 3D location and orientation of the indoor scene may be included in the geometric model of the indoor scene (e.g., being acquired during the modelling of the scene)

For example, a generic lighting model may be obtained based on the virtual outdoor condition, and the (e.g., indoor) lighting model of the indoor scene may be obtained based on the 3D location and orientation of the scene, on the generic lighting model and on the geometric model of the scene.

According to embodiments, the indoor scene may comprise an opening to the outside. For example, an opening of the indoor scene may be obtained, for example from the geometric model of the scene. The opening may be associated with a model (e.g., element) of the opening (e.g., representing any of the size, the shape, the location, the orientation). The model (e.g., element) of the opening may be included in the geometric model of the scene.

According to embodiments, a part of the (e.g., indoor) lighting model (e.g., a lighting model element) corresponding to the opening may be obtained based on the virtual outdoor condition and on the model (e.g., element) of the opening. For example, the lighting model element may include information modelling a lighting of the indoor scene, that may be induced by outdoor lighting through the opening.

According to embodiments, the model (e.g., element) of the opening may comprise an orientation of the opening relative to any of the north and the vertical, and the part of the (e.g., indoor) lighting model corresponding to the opening may be based on the virtual outdoor condition and on the orientation of the opening.

According to embodiments, the model (e.g., element) of the opening may comprise a (e.g., any of latitude and longitude) position of the opening, and the part of the (e.g., indoor) lighting model corresponding to the opening may be based on the virtual outdoor condition and on the position of the opening (e.g., the location in any of latitude and longitude of the scene).

According to embodiments, the virtual outdoor condition may be obtained from a user interface.

According to embodiments, the virtual outdoor condition may comprise an indication of any of a day of year and a time of day.

According to embodiments, the virtual outdoor condition may comprise an information indicating a weather condition.

According to embodiments, in a step S56, the rendering of the scene may be adapted by any of sending the (e.g., indoor) lighting model of the indoor scene to an external device for rendering the indoor scene by the external device, and rendering the indoor scene based on the model of the indoor scene complemented by the (e.g., indoor) lighting model of the indoor scene.

According to embodiments, an image of the indoor scene may be captured (e.g., by a camera), and the indoor scene may be rendered by rendering the image e.g., as captured by the camera, and relighted based on the (e.g., indoor) lighting model of the indoor scene.

According to embodiments, a lighting effect may be removed from the image (e.g., as captured by the camera), before applying the (e.g., indoor) lighting model of the indoor scene to the image.

According to embodiments, a virtual object may be inserted and lighted in the rendered image (e.g., processed) according to the (e.g., indoor) lighting model of the indoor scene.

According to embodiments, at least one area of the captured image may not be modelled in the geometric model of the indoor scene. The area may be color corrected based on the on the (e.g., indoor) lighting model.

According to embodiments, an opacity of the opening may be configurable via a user interface, and reflected as such in (e.g., the corresponding model element of the opening in) the (e.g., indoor) lighting model.

While not explicitly described, the present embodiments may be employed in any combination or sub-combination. For example, the present principles are not limited to the described variants, and any arrangement of variants and embodiments may be used. Moreover, embodiments described herein are not limited to the lighting models (any of direct light, ambient light, point light, environment map) and parameters (e.g., any of location, direction, color, and intensity) described herein and any other type of lighting models and/or parameters may be compatible with the embodiments described herein.

Besides, any characteristic, variant or embodiment described for a method is compatible with an apparatus device comprising means for processing the disclosed method, with a device comprising a processor configured to process the disclosed method, with a computer program product comprising program code instructions and with a non-transitory computer-readable storage medium storing program instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (e.g., but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method comprising:
obtaining information indicating an indoor scene to be rendered under a virtual outdoor condition;
obtaining a generic lighting model based on the virtual outdoor condition;
obtaining a lighting model of the indoor scene based on a geometric model of the indoor scene and on the virtual outdoor condition; and
adapting a scene rendering by any of:
sending the lighting model of the indoor scene for rendering to an external device; and
rendering the indoor scene based on the lighting model of the indoor scene.

2. (canceled)

3. The method according to claim 1, wherein said obtaining the lighting model of the indoor scene is further based on the generic lighting model.

4. The method according claim 1, wherein the indoor scene comprises an opening to outside, the geometric model of the indoor scene comprising a model of the opening.

5. The method according to claim 4, further comprising obtaining a lighting model element corresponding to the opening based on the virtual outdoor condition and on the model of the opening.

6. The method according to claim 5, wherein the model of the opening comprises an orientation of the opening relative to any of north and a vertical, the lighting model element corresponding to the opening being based on the virtual outdoor condition and on the orientation.

7. The method according to claim 5, wherein the model of the opening comprises a position of the opening, the lighting model element corresponding to the opening being based on the virtual outdoor condition and on the position.

8. The method according to claim 1, further obtaining the virtual outdoor condition from a user interface.

9. The method according to claim 1, wherein the virtual outdoor condition comprises an indication of any of a day of year and a time of day.

10. The method according to claim 1, wherein the virtual outdoor condition comprises information indicating a weather condition.

11. The method according to claim 1, further comprising capturing an image of the indoor scene, wherein said rendering the indoor scene comprises rendering the image of the indoor scene based on the lighting model of the indoor scene.

12. The method according to claim 11, further comprising removing a lighting effect in the image before applying the lighting model of the indoor scene.

13. The method according claim 11, further comprising lighting a virtual object inserted in the rendered image according to the lighting model of the indoor scene.

14. The method according to claim 11, wherein at least one area of the image is not modelled in the geometric model, the method further comprising color correcting said at least one area based on the lighting model.

15. The method according to claim 4, wherein an opacity of the opening is configurable via a user interface.

16. (canceled)

17. (canceled)

18. An apparatus comprising at least one processor configured to:
obtain information indicating an indoor scene to be rendered under a virtual outdoor condition;
obtain a generic lighting model based on the virtual outdoor condition;
obtain a lighting model of the indoor scene based on a geometric model of the indoor scene and on the virtual outdoor condition; and
adapt a scene rendering by any of:
sending the lighting model of the indoor scene for rendering to an external device; and
rendering the indoor scene based on the lighting model of the indoor scene.

19. The apparatus according to claim 18, wherein the lighting model of the indoor scene is obtained based on the generic lighting model.

20. The apparatus according to claim 18, wherein the indoor scene comprises an opening to outside, the geometric model of the indoor scene comprising a model of the opening.

21. The apparatus according to claim 20, wherein a lighting model element corresponding to the opening is obtained based on the virtual outdoor condition and on the model of the opening.

22. The apparatus according to claim 21, wherein the model of the opening comprises an orientation of the opening relative to any of north and a vertical, the lighting model element corresponding to the opening being based on the virtual outdoor condition and on the orientation.

23. The apparatus according to claim 21, wherein the model of the opening comprises a position of the opening, the lighting model element corresponding to the opening being based on the virtual outdoor condition and on the position.

24. The apparatus according to claim 18, wherein the virtual outdoor condition is obtained from a user interface.

25. The apparatus according to claim 18, wherein the virtual outdoor condition comprises an indication of any of a day of year and a time of day.

26. The apparatus according to claim 18, wherein the virtual outdoor condition comprises information indicating a weather condition.

27. The apparatus according to claim 18, wherein an image of the indoor scene is captured, and wherein said rendering the indoor scene comprises rendering the image of the indoor scene based on the lighting model of the indoor scene.

28. The apparatus according to claim 27, wherein a lighting effect is removed in the image before applying the lighting model of the indoor scene.

29. The apparatus according to claim 27, wherein a virtual object inserted in the rendered image is lighted according to the lighting model of the indoor scene.

30. The apparatus according to claim 27, wherein at least one area of the image is not modelled in the geometric model, and wherein said at least one area is color corrected based on the lighting model.

31. The apparatus according to claim 20, wherein an opacity of the opening is configurable via a user interface.
